(19) United States
(12) Patent Application Publication
(10) Pub. No.: US 2025/0174936 A1
(43) Pub. Date: May 29, 2025

(54) ELECTRICAL CONNECTION DEVICE AND PLUG CONNECTOR

(71) Applicant: Changchun Jetty Automotive Technology Co., Ltd., Changchun, Jilin Province (CN)

(72) Inventor: Chao WANG, Changchun (CN)

(21) Appl. No.: 18/841,254

(22) PCT Filed: Feb. 17, 2023
(86) PCT No.: PCT/CN2023/076768

§ 371 Date: Aug. 23, 2024

(30) Foreign Application Priority Data
Feb. 24, 2022 (CN) 202220404691.1

(51) Int. Cl. H01R 13/627; H01R 13/639

(52) U.S. Cl. CPC H01R 13/627; H01R 13/639

(57) ABSTRACT

The present disclosure provides an electrical connection device, including: a socket connector and a plug connector. The socket connector includes a socket housing, the plug connector includes a plug housing, and a front end of the plug housing is plugged into the socket housing; an outer wall of the socket housing is provided with a first latch and a second latch; the plug housing is provided with a first torsion bar mechanism and a second torsion bar mechanism, a rear end of the first torsion bar mechanism is provided with a first pressing portion, and a lower side face of the first pressing portion facing forwards is provided with a first locking hook which is in hooking fit with the first latch; and a front end of the second torsion bar mechanism is provided with a second pressing portion, and a lower side face of the second pressing portion is provided with a second locking hook which is in hooking fit with the second latch. The electrical connection device can guarantee the safety of locking and disconnection of the electrical connection, the operation is convenient, the structure is simple and the manufacturing cost is reduced.

### RELATED APPLICATION

The present disclosure claims priority to Chinese Patent Application No. 202220404691.1, entitled “electrical connection device and plug connector”, and filed on Feb. 24, 2022, which is hereby incorporated by reference in its entirety.

### TECHNICAL FIELD

The present disclosure relates to the technical field of power electronic components, and particularly to an electrical connection device and a plug connector.

### BACKGROUND

The traditional high-voltage inter-lock connector in the unlocking does not consider a problem of the time interval when an inter-lock signal circuit is disconnected from a power circuit. In the connector unlocking and unplugging process, the connector might be electrically unplugged, which leads to the ablation of contacts and even the ablation of connectors, thereby causing damages to vehicles and operators. In view of the above problems, various connector manufacturers have successively introduced connectors that can realize the step-by-step disconnection of high-voltage inter-lock and power terminals. A connector plug is designed with a primary lock structure, a secondary lock structure and a locking sheet structure. However, such structure of the connector is composed of a plurality of parts and is complicated, the cost is correspondingly increased, and there are certain potential safety hazards, so an electrical connection device is urgently needed to solve the above problems.

### SUMMARY

The present disclosure aims to provide an electrical connection device and a plug connector, so as to solve the technical problems of the complicated structure and the high manufacturing cost of a high-voltage inter-locking connector.

The above objective of the present disclosure can be achieved by adopting the following technical solutions:

An electrical connection device, including a socket connector and a plug connector, and the socket connector includes a socket housing, the plug connector includes a plug housing, and a front end of the plug housing is plugged into the socket housing;
an outer wall of the socket housing is provided with a first latch and a second latch; the plug housing is provided with a first torsion bar mechanism and a second torsion bar mechanism, a rear end of the first torsion bar mechanism is provided with a first pressing portion, and a lower side face of the first pressing portion facing forwards is provided with a first locking hook which is in hooking fit with the first latch; and a front end of the second torsion bar mechanism is provided with a second pressing portion, and a lower side face of the second pressing portion is provided with a second locking hook which is in hooking fit with the second latch.

Further, the plug housing further includes a locker, and the locker is provided with a first boss and a second boss, the locker is connected to the plug housing, the first boss is capable of preventing the first torsion bar mechanism from moving under an external force, and the second boss is capable of preventing the second torsion bar mechanism from moving under an external force.

Further, the first torsion bar mechanism is provided on an inner side of the second torsion bar mechanism.

Further, a rear end of the plug housing is provided with a first limiting boss, a rear end of the locker is provided with a limiting groove, and the first limiting boss is in limiting fit with the limiting groove to limit a backward movement of the locker.

Further, a front end of the locker is sequentially provided with a first unlocking boss and a stop block; the socket housing is provided with a second unlocking boss; the plug housing is provided with a second limiting boss, the second limiting boss is in limiting fit with the stop block, and the second unlocking boss is in limiting fit with the first unlocking boss.

Further, a rear side of the second unlocking boss is provided with a second unlocking boss inclined face, and the first unlocking boss is provided with an arc or an inclined face adapted to the second unlocking boss.

Further, the first locking hook is provided at a front side of the second locking hook.

Further, the first locking hook is provided on an inner side of the second locking hook.

Further, the socket housing is provided with at least two guide posts, the second latch is provided on the guide post, and the first latch is provided between the at least two guide posts.

Further, when the electrical connection device is in a locked state, a primary latch is in locking fit with a primary torsion bar mechanism, simultaneously a primary limiting boss abuts against the primary torsion bar mechanism and a secondary limiting boss abuts against a secondary torsion bar mechanism.

A plug connector, including a plug housing and a locker, and the plug housing is provided with a first torsion bar mechanism and a second torsion bar mechanism, a rear end of the first torsion bar mechanism is provided with a first pressing portion, and a lower side face of the first pressing portion facing forwards is provided with a first locking hook which is in hooking fit with the first latch; and a front end of the second torsion bar mechanism is provided with a second pressing portion, and a lower side face of the second pressing portion is provided with a second locking hook which is in hooking fit with the second latch; the locker is provided with a first boss and a second boss, the locker is connected to the plug housing, the first boss is capable of preventing the first torsion bar mechanism from moving under an external force, and the second boss is capable of preventing the second torsion bar mechanism from moving under an external force.

The present disclosure has the following characteristics and advantages:

In the electrical connection device, the plug housing and the socket housing are kept locked by the locker. During unlocking, an operator applies an external force to cause the locker to move, and applies an external force to the first torsion bar mechanism and the second torsion bar mechanism; the first torsion bar mechanism drives the first locking hook to move to disengage from the first latch, and the second torsion bar mechanism drives the second locking hook to disengage from the second latch, so as to achieve that the first locking hook is unlocked from the first latch and the second locking hook is unlocked from the second latch. The electrical connection device can guarantee the safety of locking and disconnection of the electric connecting device, the operation is convenient, the structure is simple and the manufacturing cost is reduced.

The first pressing portion and the second pressing portion are provided on two ends of a locking device of the plug housing respectively, so that the first pressing portion and the second pressing portion will not be pressed at the same time during unlocking, but can only be pressed separately, thereby preventing the failure of a secondary lock of an unlocking device and ensuring the stability of the electrical connection device.

### BRIEF DESCRIPTION OF THE DRAWINGS

In order to illustrate the technical solutions in the embodiments of the present disclosure more clearly, the drawings to be used in the description of the embodiments will be briefly introduced below. Obviously, the drawings involved in the following description only illustrate some embodiments of the present disclosure, and those of ordinary skill in the art can obtain other drawings from these drawings without paying any inventive effort.

FIG. 1 illustrates a structural diagram of an electrical connection device according to the present disclosure;

FIGS. 2 and 3 illustrate structural diagrams of a plug housing according to the present disclosure;

FIG. 4 illustrates a structural diagram of a socket housing according to the present disclosure;

FIGS. 5 and 6 illustrate structural diagrams of a locker according to the present disclosure;

FIG. 7 illustrates a front view of FIG. 1 of the present disclosure;

FIG. 8 illustrates a diagram of a first state of a cross-sectional view taken along A-A of FIG. 7 of the present disclosure;

FIG. 9 illustrates an enlarged view of area B of FIG. 8; and

FIG. 10 illustrates a schematic diagram of a second state of an electrical connection device of the present disclosure.

### REFERENCE NUMERALS

40: socket connector; 90: plug connector; 4: socket housing; 9: plug housing; 10: locker;
401; second latch; 402: first latch; 403: second unlocking boss; 404: guide post;
901: first torsion bar mechanism; 907: second torsion bar mechanism;
902: first locking hook; 903: second locking hook;
904: second limiting boss; 905: first limiting boss;
906: first pressing portion; 908: second pressing portion;
1001: stop block; 1002: first unlocking boss; 1003: limiting groove;
1004: second boss; 1005: first boss.

### DESCRIPTION OF THE EMBODIMENTS

The technical solutions in the embodiments of the present disclosure will be clearly and completely described below with reference to the drawings. Obviously, those described are only a part, rather than all, of the embodiments of the present disclosure. Based on the embodiments in the present disclosure, any other embodiment obtained by those of ordinary skill in the art without paying any inventive effort should fall within the protection scope of the present disclosure.

### Solution 1

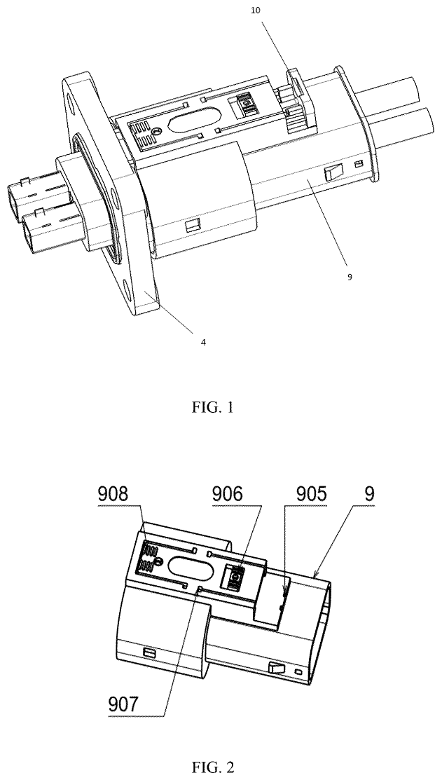

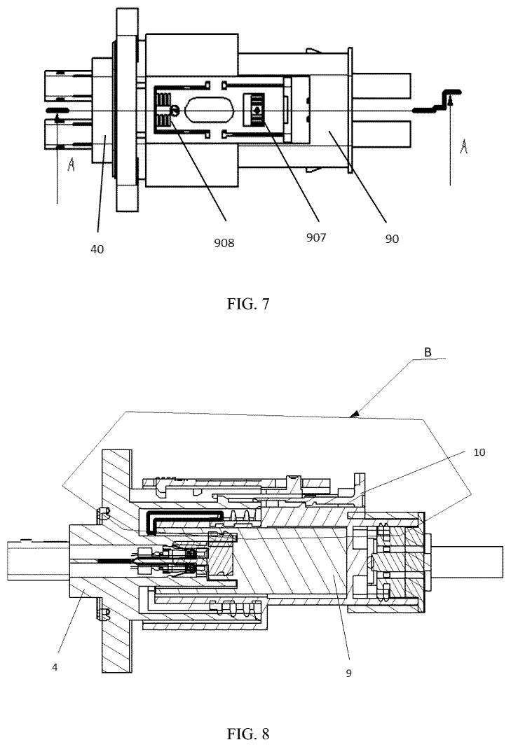

The present disclosure provides an electrical connection device, as illustrated in FIGS. 1, 4, 7, 8 and 9, which includes a socket connector 40 and a plug connector 90. The socket connector 40 includes a socket housing 4, the plug connector 90 includes a plug housing 9, and a front end of the plug housing 9 is plugged into the socket housing 4; an outer wall of the socket housing 4 is provided with a first latch 402 and a second latch 401; the plug housing 9 is provided with a first torsion bar mechanism 901 and a second torsion bar mechanism 907. A rear end of the first torsion bar mechanism 901 is provided with a first pressing portion 906, and a lower side face of the first pressing portion 906 facing forwards is provided with a first locking hook 902 which is in hooking fit with the first latch 402; and a front end of the second torsion bar mechanism 907 is provide with a second pressing portion 908, and a lower side face of the second pressing portion 908 is provided with a second locking hook 903 which is in hooking fit with the second latch 401.

When the electrical connection device is to be unlocked, an external force is applied to the first torsion bar mechanism 901 and the second torsion bar mechanism 907. The first torsion bar mechanism 901 drives the first locking hook 902 to move to disengage from the first latch 402, and the second torsion bar mechanism 907 drives the second locking hook 903 to disengage from the second latch 401, so as to achieve that the first locking hook 902 is unlocked from the first latch 402 and the second locking hook 903 is unlocked from the second latch 401. The electric connecting device can effectively guarantee the safety of locking and disconnection of the electric connecting device, the operation is convenient, the structure is simple and the manufacturing cost is reduced.

The first pressing portion 906 and the second pressing portion 908 are provided on two ends of a locking device of the plug housing respectively, so that the first pressing portion 906 and the second pressing portion 908 are not pressed at the same time during unlocking, but can only be pressed separately, thereby preventing the failure of a secondary lock of an unlocking device and ensuring the stability of the electrical connection device.

As illustrated in FIG. 1, the plug connector 90 further includes a locker 10, and the locker 10 is provided with a first boss 1005 and a second boss 1004. The locker 10 is connected to the plug housing 9. The first boss 1005 is capable of preventing the first torsion bar mechanism 901 from moving under an external force, and the second boss 1004 is capable of preventing the second torsion bar mechanism 907 from moving under an external force.

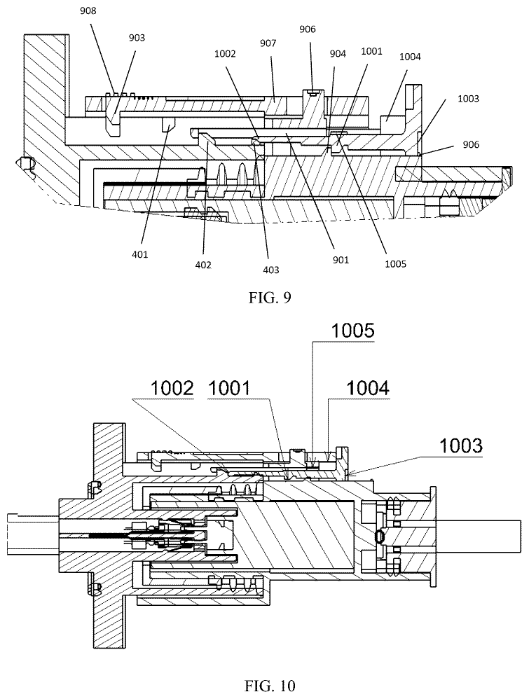

After the plug connector 90 is plugged with the socket connector 40, the locker 10 is pushed forwards. As illustrated in FIGS. 9 and 10, the position of the locker 10 remains stable, and the first boss 1005 on the locker 10 keeps the first torsion bar mechanism 901 stable, so that the first locking hook 902 is limited to a front side of the first latch 402, the plug housing 9 cannot move backwards relative to the socket housing 4, the first locking hook 902 and the first latch 402 keeps locking and remains a locked state therebetween. The first locking hook 902 and the first torsion bar mechanism 901 are integrally connected.

After the locker 10 is pushed forwards in place, the second boss 1004 on the locker 10 keeps the second torsion bar mechanism 907 stable, so that the second locking hook 903 is limited at a front side of the second latch 401. The first boss 1005 abuts against the first torsion bar mechanism 901 and the second boss 1004 abuts against the second torsion bar mechanism 907, so that the first pressing portion 906 and the second pressing portion 908 cannot be pressed down. As a result, the primary lock and the secondary lock cannot be unlocked, and the plug housing 9 cannot move backwards relative to the socket housing 4.

During unlocking, the operator presses the first pressing portion 906 to move the locker 10 relative to the plug housing 9, and the first boss 1005 deviates from the first torsion bar mechanism 901. Next, the first torsion bar mechanism 901 drives the first locking hook 902 to move to disengage from the first latch 402, so as to achieve that the first locking hook 902 is unlocked from the first latch 402.

As the plug housing 9 and the socket housing 4 are unlocked backwards, the second locking hook 903 and the second latch 401 are in a locked state, and then the second pressing portion 908 is pressed and the connector is unlocked backwards, at which time the second locking hook 903 and the second latch 401 are unlocked.

The plug housing 9 may move backwards relative to the socket housing 4 to disconnect the plug connector 90 from the socket connector 40. The electrical connection device can guarantee the safety of locking and disconnection of the electrical connection, the operation is convenient, the structure is simple and the manufacturing cost is reduced.

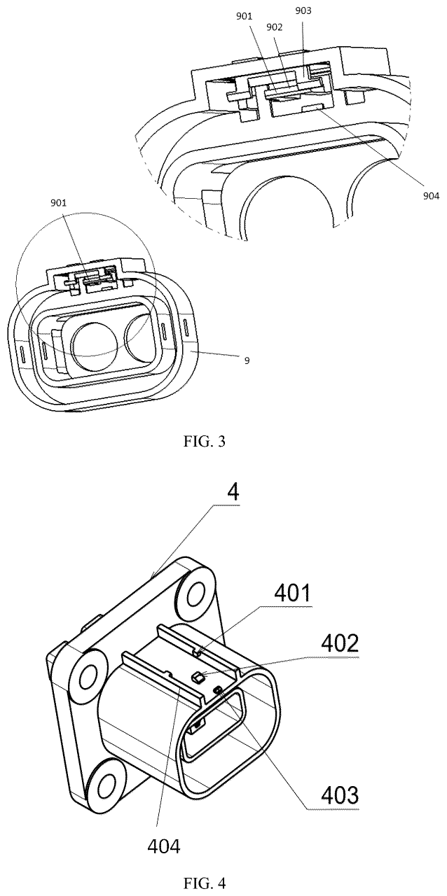

In a specific embodiment, as illustrated in FIG. 3, the first torsion bar mechanism 901 is provided on an inner side of the second torsion bar mechanism 907.

By providing the first torsion bar mechanism 901 on the inner side of the second torsion bar mechanism 907, the structure of the electrical connection device is more compact and the unlocking effect can be achieved with a smaller space.

In a specific embodiment, as illustrated in FIG. 2, a rear end of the plug housing 9 is provided with a first limiting boss 905, a rear end of the locker 10 is provided with a limiting groove 1003, and the first limiting boss 905 is in limiting fit with the limiting groove 1003 to limit a backward movement of the locker 10.

With this structure, the position of the locker 10 on the plug housing 9 can be kept stable, and an operator can unlock the locker 10 by applying a sufficient external force, so that the structure is simple, the connection is safe and reliable, the operation is convenient and the manufacturing cost is low.

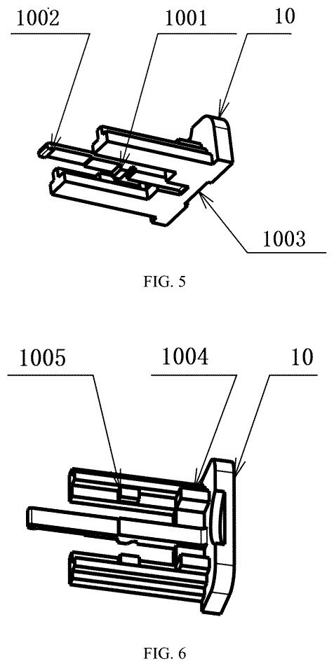

In a specific embodiment, as illustrated in FIGS. 2, 5, 6 and 9, a front end of the locker 10 is sequentially provided with a first unlocking boss 1002 and a stop block 1001; the socket housing 4 is provided with a second unlocking boss 403; the plug housing 9 is provided with a second limiting boss 904, the second limiting boss 904 is in limiting fit with the stop block 1001, and the second unlocking boss 403 is in limiting fit with the first unlocking boss 1002.

When the plug connector 90 and the socket connector 40 are not plugged, the second unlocking boss 403 lifts up the first unlocking boss 1002; at this time, the limiting effect of the second limiting boss 904 on the stop block 1001 disappears, and the locker 10 is capable of continuing to be pushed forwards. The second limiting boss 904 limits the stop block 1001, and the first limiting boss 905 limits the limit groove 1003, so that the locker 10 cannot be pushed forwards any more.

In a specific embodiment, as illustrated in FIG. 9, a rear side of the second unlocking boss 403 is provided with a second unlocking boss 403 inclined face, and the first unlocking boss 1002 is provided with an arc or an inclined face adapted to the second unlocking boss 403.

When the plug connector 90 and the socket connector 40 are plugged or unlocked, the designed arc or the inclined face is advantageous in that when the locker 10 is stressed, the first unlocking boss 1002 and the second unlocking boss 403 can easily slide relative to each other, which is convenient for operation.

In a specific embodiment, the first locking hook 902 is provided at a front side of the second locking hook 903.

The second locking hook 903 is provided at a front side of the first locking hook 902, and the second latch 401 is located at a front side of the first latch 402. In an embodiment, a distance between the second locking hook 903 and the first locking hook 902 is larger than a distance between the second latch 401 and the first latch 402. When the first locking hook 902 abuts against the first latch 402, the second locking hook 903 is located at the front side of the second latch 401 with a distance. When the first locking hook 902 and the first latch 402 are unlocked and the plug connector 90 moves backwards for a distance, the second locking hook 903 abuts against the second latch 401, and they are in locked fit. The operator continues to unlock the second torsion bar machine 907, and the second locking hook 903 and the second latch 401 are unlocked. In the electrical connection device, the first-stage and second-stage unlocking steps should be carried out one by one, which solves the problem of a time interval when an inter-lock signal circuit is disconnected from a power circuit and improves the safety.

In a specific embodiment, the first locking hook 902 is provided on an inner side of the second locking hook 903.

The first locking hook 902 and the first latch 402 are fitted with each other, and the second locking hook 903 and the second latch 401 are fitted with each other. The first locking hook 902 is provided at a front end of the first torsion bar mechanism 901, and a rear end of the first torsion bar mechanism 901 is provided with a first pressing portion 906. The operator presses the first pressing portion 906 inwards to drive the first torsion bar mechanism 901 to move and cause the first locking hook 902 to move outwards, so as to be disengaged from the first latch 402. At this time, the plug housing 9 and the socket housing 4 move in opposite directions. Further, when the first boss 1005 of the locker 10 is located on an inner side of the first pressing portion 906, the first pressing portion 906 can be prevented from moving inwards when pressed, so that the first locking hook 902 and the first latch 402 remain locked.

In a specific embodiment, the socket housing 4 is provided with at least two guide posts 404, the second latch 401 is provided on the guide post 404, and the first latch 402 is provided between the at least two guide posts 404.

As illustrated in FIG. 4, the socket housing 4 is provided with at least two guide posts 404, on which the second latches 401 are provided respectively, the first latch 402 is provided between the at least two guide posts 404, the two second latches 401 are distributed on two sides of the first latch 402, and the second locking hook 903 on the plug housing 9 fits with the second latches 401 on the two sides to improve the reliability of the locked fit.

In a specific embodiment, when the electrical connection device is in a locked state, the first latch 402 is in locking fit with the first torsion bar mechanism 901, simultaneously the first boss 1005 abuts against the first torsion bar mechanism 901 and the second boss 1004 abuts against the second torsion bar mechanism 907.

After the locker 10 is pushed forwards in place, the second boss 1004 on the locker 10 keeps the second torsion bar mechanism 907 stable, so that the second locking hook 903 is limited at a front side of the second latch 401. The first boss 1005 abuts against the first torsion bar mechanism 901 and the second boss 1004 abuts against the second torsion bar mechanism 907, so that the first pressing portion 906 and the second pressing portion 908 cannot be pressed down. As a result, the primary lock and the secondary lock cannot be unlocked, and the plug housing 9 cannot move backwards relative to the socket housing 4.

The use method of the electrical connection device includes a locking step and an unlocking step.

The locking step: when the plug connector 90 and the socket connector 40 are plugged, the second unlocking boss 403 lifts up the first unlocking boss 1002; at this time, the limiting effect of the second limiting boss 904 on the stop block 1001 disappears, and the locker 10 continues to be pushed forwards. When the locker 10 is pushed in place, the first latch 402 is in locking fit with the first locking torsion bar structure 901, simultaneously the first boss 1005 abuts against the first torsion bar mechanism 901 and the second boss 1004 abuts against the second torsion bar mechanism 907, so that the first pressing portion 906 and the second pressing portion 908 cannot be pressed down. As a result, the primary lock and the secondary lock cannot be unlocked.

The unlocking step: the locker 10 is unplugged towards the first limiting boss 905, the first pressing portion 906 is pressed and the connector is unlocked backwards; at this time, the first locking hook 902 and the first latch 402 are successfully unlocked, and as the connector is unlocked backwards, the second locking hook 903 is in locking fit with the second latch 401 at this time; next, the second pressing portion 908 is pressed and the connector is unlocked backwards, and at this time, the second locking hook 903 and the second latch 401 are unlocked.

In the present disclosure, the primary lock structure and the secondary lock structure are made into an integral structure with the plug housing 9, and the unlocking structures are made into torsion bar structures, so that the operation is convenient, the connection is safe and reliable, and the manufacturing cost is low; the first pressing portion 906 and the second pressing portion 908 are designed at different positions to avoid the failure of the secondary lock caused by pressing a secondary unlocking button during the primary unlocking.

### Solution 2

A plug connector includes a plug housing 9 and a locker 10. The plug housing 9 is provided with a first torsion bar mechanism 901 and a second torsion bar mechanism 907, a rear end of the first torsion bar mechanism 901 is provided with a first pressing portion 906, and a lower side face of the first pressing portion 906 facing forwards is provided with a first locking hook 902 which is in hooking fit with the first latch 402; and
a front end of the second torsion bar mechanism 907 is provided with a second pressing portion 908, and a lower side face of the second pressing portion 908 is provided with a second locking hook 903 which is in hooking fit with the second latch 401;
the locker 10 is provided with a first boss 1005 and a second boss 1004, the locker 10 is connected to the plug housing 9, the first boss 1005 is capable of preventing the first torsion bar mechanism 901 from moving under an external force, and the second boss 1004 is capable of preventing the second torsion bar mechanism 907 from moving under an external force.

The plug connector is connected with the fitted socket connector, and the plug housing 9 and the socket housing 4 are kept locked by the locker 10. During unlocking, an operator presses the first pressing portion 906 so that the locker 10 moves relative to the plug housing 9, and the first boss 1005 deviates from the first torsion bar mechanism 901. Next, the first torsion bar mechanism 901 drives the first locking hook 902 to move to disengage from the first latch 402, thereby unlocking the first locking hook 902 and the first latch 402.

As the plug housing 9 and the socket housing 4 are unlocked backwards, the second locking hook 903 and the second latch 401 are in a locked state, and then the second pressing portion 908 is pressed and the connector is unlocked backwards, at which time the second locking hook 903 and the second latch 401 are unlocked.

The structure is simple and convenient for operation, and the manufacturing cost is reduced.

Those described above are just several embodiments of the present disclosure, and those skilled in the art can make various modifications or variations to the embodiments of the present disclosure according to the contents disclosed herein without departing from the spirit and scope of the present disclosure.

1. An electrical connection device, comprising a socket connector and a plug connector, wherein the socket connector comprises a socket housing, the plug connector comprises a plug housing, and a front end of the plug housing is plugged into the socket housing;
an outer wall of the socket housing is provided with a first latch and a second latch;
the plug housing is provided with a first torsion bar mechanism and a second torsion bar mechanism, a rear end of the first torsion bar mechanism is provided with a first pressing portion, and a lower side face of the first pressing portion facing forwards is provided with a first locking hook which is in hooking fit with the first latch; and
a front end of the second torsion bar mechanism is provided with a second pressing portion, and a lower side face of the second pressing portion is provided with a second locking hook which is in hooking fit with the second latch.

2. The electrical connection device according to claim 1, wherein the plug housing further comprises a locker, and the locker is provided with a first boss and a second boss, the locker is connected to the plug housing, the first boss is capable of preventing the first torsion bar mechanism from moving under an external force, and the second boss is capable of preventing the second torsion bar mechanism from moving under an external force.

3. The electrical connection device according to claim 1, wherein the first torsion bar mechanism is provided on an inner side of the second torsion bar mechanism.

4. The electrical connection device according to claim 2, wherein a rear end of the plug housing is provided with a first limiting boss, a rear end of the locker is provided with a limiting groove, and the first limiting boss is in limiting fit with the limiting groove to limit a backward movement of the locker.

5. The electrical connection device according to claim 2, wherein a front end of the locker is sequentially provided with a first unlocking boss and a stop block;
the socket housing is provided with a second unlocking boss;
the plug housing is provided with a second limiting boss, the second limiting boss is in limiting fit with the stop block, and the second unlocking boss is in limiting fit with the first unlocking boss.

6. The electrical connection device according to claim 5, wherein a rear side of the second unlocking boss is provided with a second unlocking boss inclined face, and the first unlocking boss is provided with an arc or an inclined face adapted to the second unlocking boss.

7. The electrical connection device according to claim 1, wherein the first locking hook is provided at a front side of the second locking hook.

8. The electrical connection device according to claim 1, wherein the first locking hook is provided on an inner side of the second locking hook.

9. The electrical connection device according to claim 1, wherein the socket housing is provided with at least two guide posts, the second latch is provided on the guide post, and the first latch is provided between the at least two guide posts.

10. The electrical connection device according to claim 5, wherein when the electrical connection device is in a locked state, the first latch is in locking fit with the first torsion bar mechanism, simultaneously the first boss abuts against the first torsion bar mechanism and the second boss abuts against the second torsion bar mechanism.

11. A plug connector, comprising a plug housing and a locker, wherein the plug housing is provided with a first torsion bar mechanism and a second torsion bar mechanism, a rear end of the first torsion bar mechanism is provided with a first pressing portion, and a lower side face of the first pressing portion facing forwards is provided with a first locking hook which is in hooking fit with the first latch; and
a front end of the second torsion bar mechanism is provided with a second pressing portion, and a lower side face of the second pressing portion is provided with a second locking hook which is in hooking fit with the second latch; and
the locker is provided with a first boss and a second boss, the locker is connected to the plug housing, the first boss is capable of preventing the first torsion bar mechanism from moving under an external force, and the second boss is capable of preventing the second torsion bar mechanism from moving under an external force.
